(19) United States
(12) Patent Application Publication
(10) Pub. No.: US 2011/0272041 A1
(43) Pub. Date: Nov. 10, 2011

(54) SYSTEM OF CONNECTING THERMOSTATIC MIXING VALVE WITH THE SINK AND MINI SHOWER

(76) Inventor: Murad Dharani, Toronto (CA)

(21) Appl. No.: 12/773,029

(22) Filed: May 4, 2010

(51) Int. Cl. F16K 11/00

(52) U.S. Cl. 137/315.09

(57) ABSTRACT

A system of providing a menus of connecting the thermostatic mixing valve specially designed in T-shape configuration with a mini shower as well as sink basin, is made to meet the requirement getting the comfortably blended water at stable temperature. The sole purpose is to make the user more comfortable and convenient to use in cleaning, washing after toilet or bathing purposes and at the same time always keep in good hygienic condition.

### TECHNICAL FIELD OF THE INVENTION

The present invention relates more particularly to the bathroom accessories. It relates to the system of using mini shower connecting to a thermostatic mixing valve which can be affixed to a sink basin by simple plumbing work.

### BACKGROUND

Thermostatic mixing valve is used for blending hot and cold water with the result that the water is delivered at the required temperature thereby reducing the risk of scalding accident.

As is well known to those skilled in the art, there are devices called faucets which are used in bathrooms, kitchens and other facilities. Faucets are mixing valves for mixing hot and cold water which usually comprises of a cold water inlet, a hot water inlet, a mixing chamber and one or more valves to control water flow into the chamber. The mixing valve maintains both stable temperature and flow of outcomming water. It takes time for the manual adjustment of water temperature even if the temperature and the pressure of the cold and hot inlets are stable. However, the temperature and pressure of the inlets does not usually remain constant and frequently fluctuate due to loads on the pipelines and other conditions. This implies that the faucet does not provide temperature stability for outcomming water.

Thermostatic valve fulfills the requirement of improving stabilization of the temperature of the outcomming water. A thermostatic mixing valve is a mechanical device that mixes hot and cold water to give warm water at a safe, preset temperature. It works on the expansion and contraction of a temperature sensitive element in response to the varying water supply temperatures and pressures of hot and cold water inlets. This expansion and contraction moves a sliding valve which varies the amount of hot and cold water at a constant temperature. The valve will also shut down if either water supply fails. As for example, if the cold water supply fails, the element will expand and push the slide valve down, closing off the hot water supply and preventing scalding water reaching the user. The thermostatic mixing valve which comprises of thermally responsive element can be seen in the U.S. Pat. Nos. 5,108,032, 5,110,044 and 5,203,496 in which a valve controls the relatively for hot and cold water flows. However it can not provide the stable temperature since any variation in the hot and cold water pressure results in the fluctuation of water outlet temperature. Another thermostatic mixing valve in U.S. Pat. No. 5,1810,737, is able to equalize pressure in both inlets and then stabilize the temperature. However, temperature variation in outlet still prevails when there are any temperature changes of the incoming fluid in the inlet.

The system of connecting the thermostatic mixing valve with both the basin and the shower cannot be found anywhere in the prior art.

### SUMMARY

The invention is characterized by a thermostatic mixing valve freely adapted to the existing piping of hot and cold water. Since the toilets are generally located near the sink in the washroom, the connection does not require a lot of work. The thermostatic mixing valve allows the setting of the blended water at a constant and uniform temperature in the hot tap as well as in the mini shower. Further, the temperature can also be lowered at the same time by turning on the cold tap which allows the double mixing of the blended water and the cold water.

### BRIEF DESCRIPTION OF THE DRAWING

FIG. 1 shows a perspective view of a thermostatic mixing valve of water distribution connecting system.

FIG 2. shows the left side view of the thermostatic mixing valve of the water distribution connecting system.

FIG. 3 shows right side view of the thermostatic mixing valve of the water distribution connecting system.

FIG. 4 is the front view of the water distribution connecting system with the shower and the sink.

FIG. 5 is the back view of the water distribution connecting system with the shower and the sink.

FIG 6. shows the mini shower assembly.

### DETAILED DESCRIPTION

The present invention uses a thermostatic mixing valve which allows the temperature of the outcomming water to be stable and already preset at 47° C.

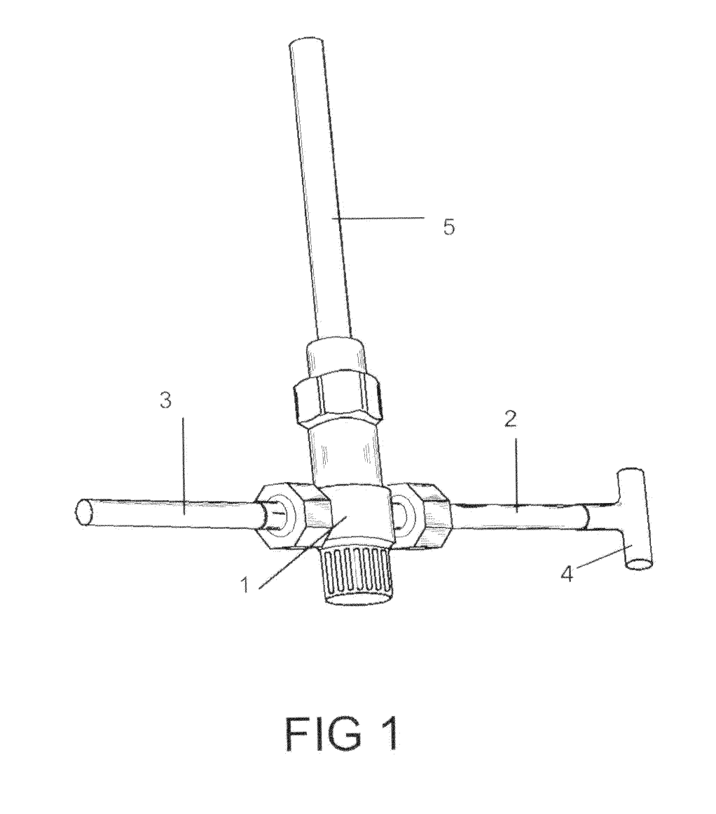

FIG. 1 shows the thermostatic mixing valve. The first embodiment of the invention is the designed of the T-shaped thermostatic mixing valve. The mixing of the hot and cold water is done in the main mixing chamber (1) inside the thermostatic mixing valve (TMV). T-shape TMV is essentially consists of three pipes of certain length projecting outward. Then there are two pipes inlets on either side of TMV extending outwards in the opposite direction. These inlets serve the purpose of the entry of cold and hot water into the TMV mixing chamber. The cold water inlet pipe (2) is characterized by the presence of T-shape joint connecter (4) at its end and is aligned at right angle to the axis of the cold water inlet pipe. The connector serves as the means of joining TMV with the already existing ordinary cold water pipe attached with the sink basin (11). The hot water inlet pipe (3) is connected to the pipe carrying hot water supplied from the heat source. The heat source allows water to store at high temperature. There is one outlet pipe from TMV where blended water at the desired temperature and pressure comes out after mixing with cold and hot water inside the mixing chamber. The TMV assembly is designed in such a way that it can be easily installed to the sink basin. For this purpose, the cold water pipe inlet is in T-shape and is connected to the already existing cold water main pipe (12) in such a way that the cold water can flow into the basin sink via cold water tap as well as into the TMV mixing chamber.

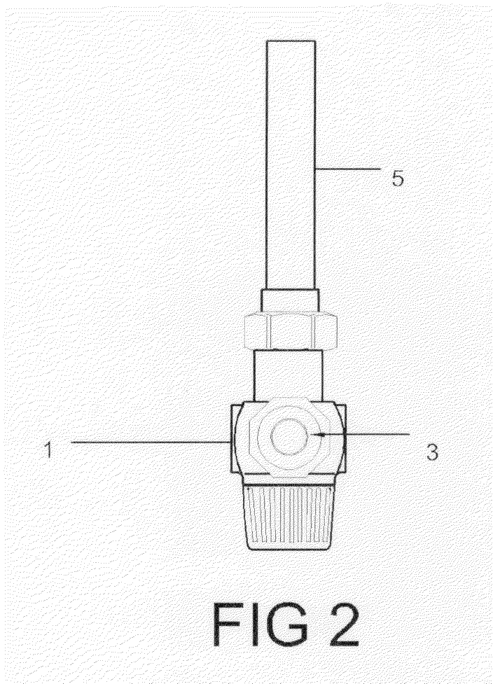

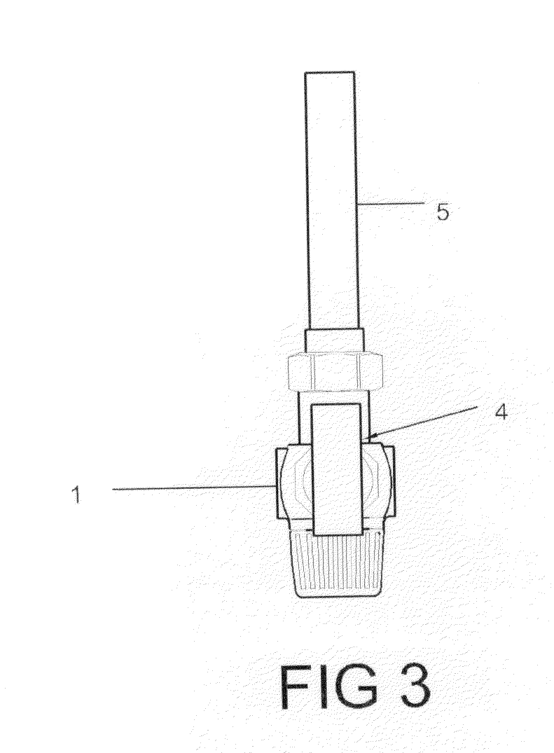

FIG. 2 is the left side view of TMV showing the hot inlet pipe entry (3) and FIG. 3 is the right side view of the TMV showing the T-shaped joint connector (4).

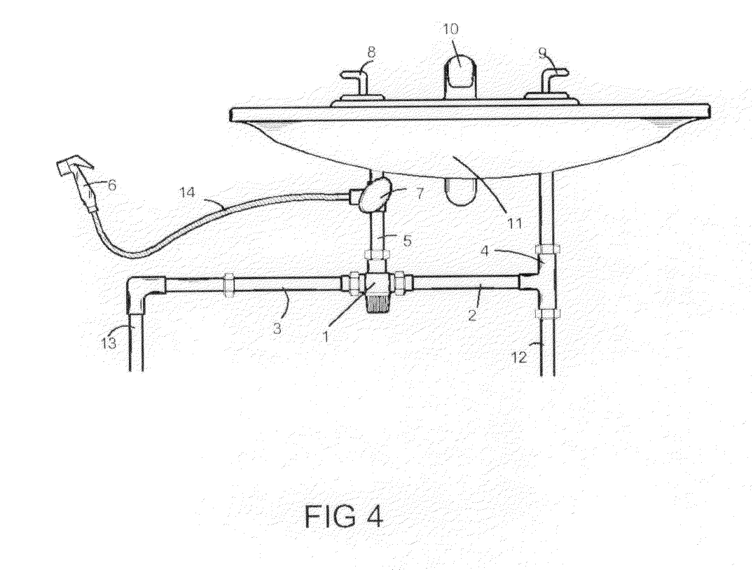

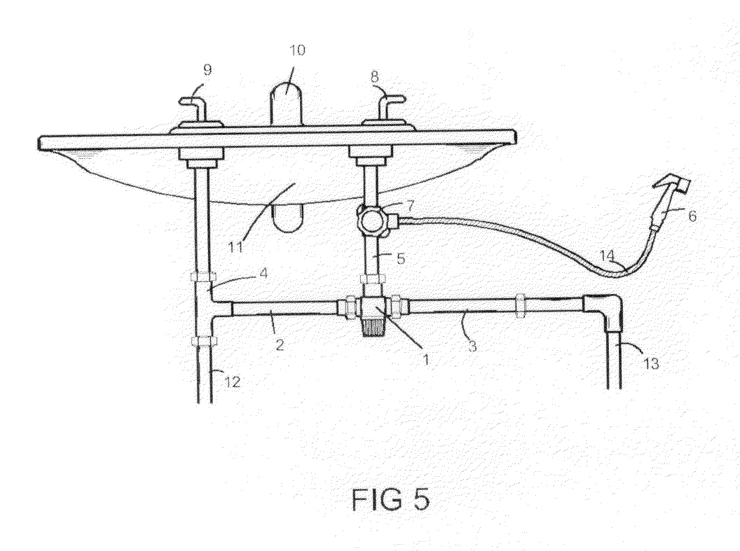

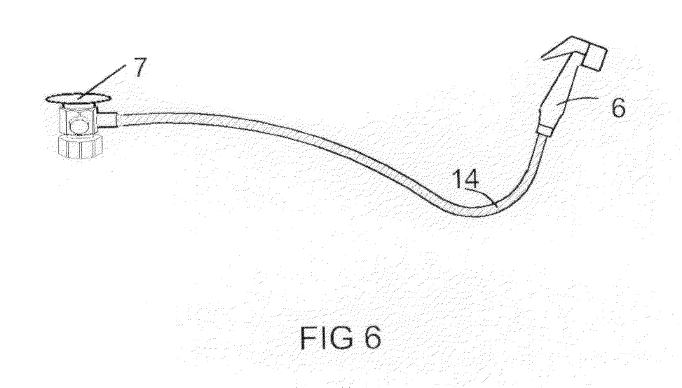

Another embodiment of the present invention is the mode of attachment of the mini shower at the TMV outlet pipe as shown in FIG. 4 and FIG. 5. FIG. 6 shows a mini shower assembly has a specially designed connector (7) at its end. The connector (7) connects TMV blended water outlet pipe with the pipe connected to sink tap; both the pipes are aligned vertically in a straight line. The connection of the mini shower with the sink basin and the TMV can be done by a simple plumbing work without much effort. In this way, comfortably warm water at preset temperature (47° C.) can be made available to the mini shower as well as the sink tap. This makes the user convenient and easy to use since the toilet is generally located sink basin in the bathroom.

Another embodiment of the invention is that the system allows the possibility of providing double mixing of waters. At times blended water from TMV may feel uncomfortably hot to a user while using water from the faucet (10). In such case, the water from the sink tap (8) can be cooled by allowing to mix the hot water in the sink with cold water. This is done by turning the cold water tap (9) in the ‘on’ position position thereby lowering the temperature. The flow rate of cold water for mixing with the blended water can be adjusted in the cold tap until the comfortably warm water is obtained in the sink.

Thus the present invention is found to be unique and has novelty in every aspect as compared with the existing prior arts.

What is claimed is:

1. A thermostatic mixing valve (TMV) assembly connecting a mini shower, comprising an inlet water pipe with a T-shaped connector at its end to provide means of connection to cold water pipe.

2. The TMV assembly connecting a mini shower in claim 1, wherein the said TMV is freely adapted to the sink basin to
provide both comfortably warm and cold water to the sink,
provide warm water to the mini shower at a preset temperature and pressure.

3. The TMV connecting a mini shower in claim 1, wherein the said mini shower is having a specially designed connector at its end, thereby providing a means of connection of TMV to the sink pipe.

4. The system of connecting a mini shower and sink basin to a common TMV by a simple plumbing process.

5. The system of claim 4, wherein providing a means of double mixing waters to lower the temperature of the uncomfortably blended water from the sink tap by allowing to mix with cold water when turning the cold tap in the ‘on’ position.
